(19) United States
(12) Patent Application Publication
(10) Pub. No.: US 2026/0121465 A1
(43) Pub. Date: Apr. 30, 2026

(54) ROTOR AND METHOD OF MANUFACTURING THE SAME

(71) Applicant: TOYOTA JIDOSHA KABUSHIKI KAISHA, Toyota-shi (JP)

(72) Inventor: Motoaki KAMIMURA, Toyota-shi (JP)

(73) Assignee: TOYOTA JIDOSHA KABUSHIKI KAISHA, Toyota-shi (JP)

(21) Appl. No.: 19/009,019

(22) Filed: Jan. 3, 2025

(30) Foreign Application Priority Data
Mar. 7, 2024 (JP) 2024-034524

(51) Int. Cl. H02K 1/26; H02K 3/46; H02K 13/00; H02K 13/02; H02K 15/026; H02K 15/40

(52) U.S. Cl. CPC H02K 1/26; H02K 3/46; H02K 13/003; H02K 13/02; H02K 15/026; H02K 15/40; H02K 2203/09

(57) ABSTRACT

A rotor according to the present disclosure includes a rotor body including a field coil, a shaft fixed to the rotor body and constituting a rotating shaft, a first resin molded body covering an outer peripheral surface of the shaft protruding from the rotor body in the direction of the rotating shaft, a slip ring installed on an outer peripheral surface of the first resin molded body, one end is electrically connected to the slip ring in the first resin molded body, and the other end is a rotor provided with a bus bar protruding from the first resin molded body and electrically connected to the field coil, and the other end of the bus bar protruding from the first resin molded body is sealed to the second resin molded body separate from the first resin molded body.

### CROSS-REFERENCE TO RELATED APPLICATION

This application claims priority to Japanese Patent Application No. 2024-034524 filed on Mar. 7, 2024, incorporated herein by reference in its entirety.

### BACKGROUND

### 1. Technical Field

The present disclosure relates to a rotor and a method of manufacturing the rotor.

### 2. Description of Related Art

A rotor that supplies electric power to a field coil provided in a rotor core via a slip ring in contact with a brush is known. A current flows from the brush to the slip ring and from the slip ring to the field coil via a connection terminal (hereinafter referred to as a “bus bar”). Oil is supplied to the rotor for cooling and lubrication. However, this oil may cause a poor electrical connection between the brush and the slip ring. The oil adhering to the field coil provided in the rotor core travels through the bus bar held by a resin molded body through capillary action, and flows from the coil side to the slip ring side in the resin molded body. The oil having flowed to the slip ring side reaches the outer peripheral surface of the slip ring through a gap between the resin molded body and the slip ring. That is, an oil film is formed on the outer peripheral surface of the slip ring in contact with the brush, making the electrical connection between the brush and the slip ring poor.

To address such an issue, Japanese Unexamined Patent Application Publication No. 2020-202624 (JP 2020-202624 A) discloses a structure in which a protrusion is provided on a side surface of a slip ring in contact with a resin molded body to suppress oil reaching the outer peripheral surface of the slip ring.

### SUMMARY

The inventor has found the following issue with the rotor disclosed in JP 2020-202624 A. During operation of the rotor, the slip ring continues to be stressed by contact with the brush. Therefore, the slip ring is deformed by wear or stress, and a gap is formed between the protrusion provided on the side surface of the slip ring and the resin molded body, and there is a possibility that the oil reaches the outer peripheral surface of the slip ring.

The present disclosure provides a rotor capable of suppressing oil reaching the outer peripheral surface of a slip ring, and a method of manufacturing the rotor.

An aspect of the present disclosure provides a rotor including:
a rotor body including a field coil;
a shaft fixed to the rotor body and constituting a rotary shaft;
a first resin molded body that covers an outer peripheral surface of the shaft protruding in a direction of the rotary shaft from the rotor body;
a slip ring installed on an outer peripheral surface of the first resin molded body; and
a bus bar, one end of which is electrically connected to the slip ring in the first resin molded body, and the other end of which protrudes from the first resin molded body to be electrically connected to the field coil, in which
the entire other end of the bus bar protruding from the first resin molded body is sealed by a second resin molded body that is separate from the first resin molded body. Accordingly, it is possible to suppress oil reaching the outer peripheral surface of the slip ring.

The field coil may include a coil end portion at both end portions in the direction of the rotary shaft of the rotor body; and the coil end portion on the first resin molded body side may be fixed by the second resin molded body.

The field coil may be sealed by the second resin molded body in the rotor body.

Another aspect of the present disclosure provides a method of manufacturing a rotor, including:
integrating a slip ring and a bus bar with a first resin molded body;
covering an outer peripheral surface of a shaft with the first resin molded body; and
fixing the shaft constituting a rotary shaft to a rotor body, and causing the first resin molded body to protrude in a direction of the rotary shaft from the rotor body, in which: one end of the bus bar sealed in the first resin molded body is electrically connected to the slip ring installed on an outer peripheral surface of the first resin molded body, and the other end of the bus bar protruding from the first resin molded body is electrically connected to a field coil provided in the rotor body; and
the entire other end of the bus bar protruding from the first resin molded body is sealed by a second resin molded body that is separate from the first resin molded body.

According to the present disclosure, it is possible to provide a rotor capable of suppressing oil reaching the outer peripheral surface of a slip ring, and a method of manufacturing the rotor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a rotor according to the present disclosure;

FIG. 2 is a perspective view of the rotor according to the present disclosure except for the second resin molded body;

FIG. 3 is a perspective view of a rotor according to the present disclosure;

FIG. 4 is a plan view of a rotor according to the present disclosure; and

FIG. 5 is a flowchart of a method of manufacturing a rotor according to the present disclosure.

### DETAILED DESCRIPTION OF EMBODIMENTS

### First Embodiment

Hereinafter, a rotor and a manufacturing method thereof according to the present disclosure will be described with reference to the drawings.

### Rotor Configuration

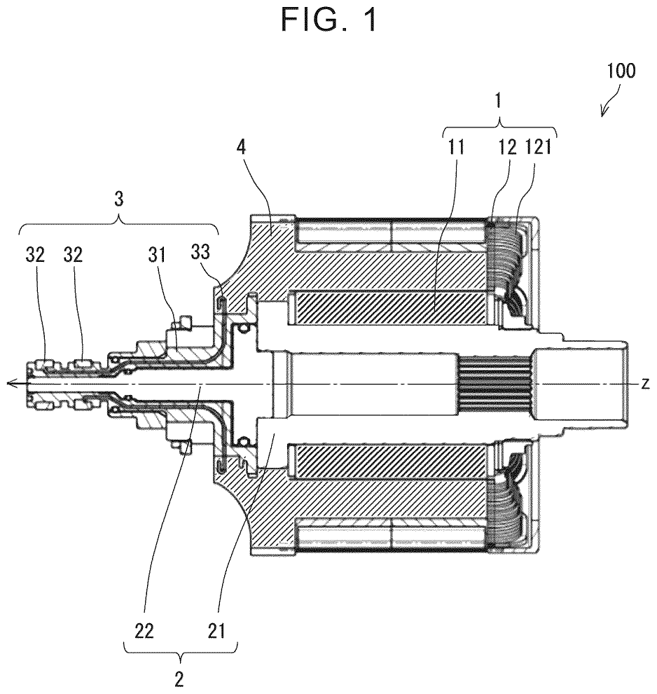

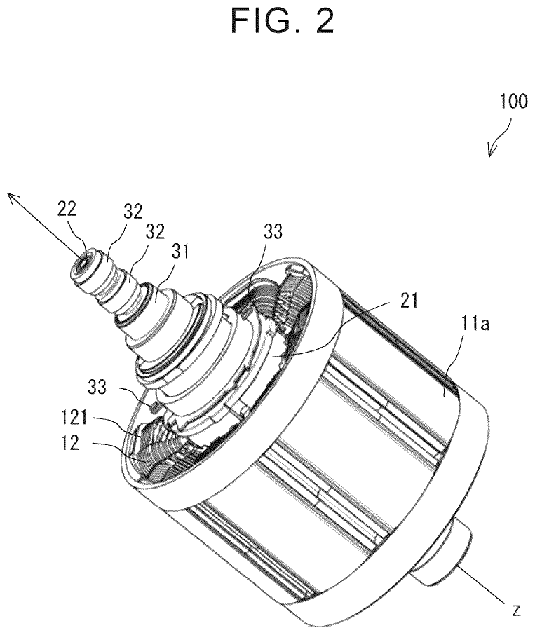

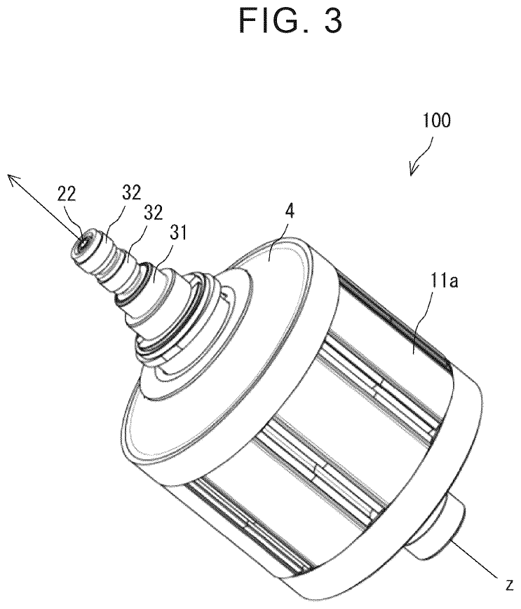

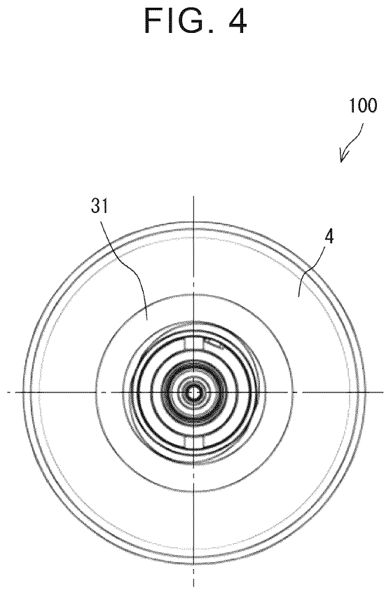

First, a configuration of a rotor according to the present disclosure will be described with reference to FIGS. 1 to 4. FIG. 1 is a cross-sectional view of a rotor according to the present disclosure. FIG. 2 is a perspective view of the rotor according to the present disclosure except for the second resin molded body. FIG. 3 is a perspective view of a rotor according to the present disclosure. FIG. 4 is a plan view of a rotor according to the present disclosure.

As illustrated in FIG. 1, the rotor 100 includes a rotor body 1, a shaft 2, a slip ring device 3, and a second resin molded body 4.

The rotor body 1 rotates about a rotation axis (z-axis) of the shaft 2. The rotor body 1 includes a rotor core 11 and a field coil 12. The rotor core 11 is a magnetic member. As shown in FIG. 2, the rotor core 11 has a shaft bore in which a plurality of protruding portions 11a are disposed on the outer periphery thereof and the shaft 2 is fixed to the center portion thereof. The field coil 12 is a winding that is annularly wound on the outer peripheral surface of the protruding portion 11a of the rotor core 11, and generates a magnetic field. A coil end portion 121 which is a part of the field coil 12 protrudes from both end portions in the axial direction of the rotation axis (z-axis) of the rotor core 11.

Further, in at least two protruding portions 11a of the rotor core 11, a lead wire (not shown) for electrically connecting to the bus bar 33 extends from one end of the field coil 12 provided in the protruding portion 11a. The other end of the field coil 12 provided with the lead wire, the other end of the field coil 12 provided on the other protruding portion 11a crossover wire (not shown) extends. Then, the field coils 12 provided in the protruding portions 11a adjacent to each other in the circumferential direction of the rotating shaft (z-axis) are electrically connected to each other by a crossover wire.

The shaft 2 is a rod-shaped member fixed to the rotor body 1 and constituting a rotation axis (z-axis). The shaft 2 includes a main shaft 21 and a sub-shaft 22. The shaft 2 rotates integrally with the slip ring device 3 and the second resin molded body 4 in addition to the rotor body 1. The main shaft 21 and the sub-shaft 22 may be cylindrical members.

The slip ring device 3 includes a first resin molded body 31, a slip ring 32, and a bus bar 33. The slip ring device 3 is fixed to the shaft 2 protruding from the rotor body 1 in the direction of the rotation axis (z-axis).

The first resin molded body 31 is formed so as to cover the outer peripheral surface of the shaft 2 protruding from the rotor body 1 in the direction of the rotation axis (z-axis). The first resin molded body 31 is fixed to the shaft 2 by press-fitting into the shaft 2, for example. The first resin molded body 31 is formed by molding an insulating resin. The first resin molded body 31 rotates integrally with the shaft 2. The first resin molded body 31 includes a slip ring 32 and a bus bar 33.

The slip ring 32 is an annular member installed on the outer peripheral surface of the first resin molded body 31. The slip ring 32 is made of, for example, a copper-based metal having excellent electrical conductivity. The slip ring 32 rotates integrally with the first resin molded body 31 while being in contact with a brush (not shown) on the outer peripheral surface of the slip ring 32. A current is supplied to the brush from, for example, a motor control device. The supplied current is supplied to the field coil 12 provided in the rotor body 1 via the brush, the slip ring 32, and the bus bar 33. As a result, a magnetic field is generated in the field coil 12 of the rotor body 1.

The bus bar 33 electrically connects the slip ring 32 and the field coil 12. Specifically, one end of the bus bar 33 is electrically connected to the slip ring 32 in the first resin molded body 31, and the other end protrudes from the first resin molded body 31 and is electrically connected to the field coil 12. For example, the slip ring 32 and the field coil 12 of the bus bar 33 are connected to each other by welding. The material of the bus bar 33 is, for example, a copper-based metal having excellent electrical conductivity.

The second resin molded body 4 is disposed on the outer peripheral surface of the first resin molded body 31 so as to be separated from the slip ring in the axial direction of the rotation axis (z-axis). The second resin molded body 4 is formed by molding an insulating resin. The second resin molded body 4 seals the entire other end of the bus bar 33 protruding from the first resin molded body 31. The bus bar 33 is electrically connected to the field coil 12 in a state of being sealed to the second resin molded body 4 separate from the first resin molded body 31. In other words, the bus bar 33 is electrically connected to the slip ring 32 and the field coil 12 in a state of being sealed to the first resin molded body 31 and the second resin molded body 4. According to such a configuration, it is possible to prevent the oil supplied to the rotor body 1 from adhering to the bus bar 33. Therefore, the oil does not leak to the slip ring 32 through a slight gap through the bus bar 33 due to capillary action. Therefore, it is possible to prevent the oil from reaching the outer peripheral surface of the slip ring 32.

In the first embodiment, as shown in FIGS. 1 and 3, the second resin molded body 4 has a shape in which the field coil 12 is sealed in the rotor body 1. However, the shape of the second resin molded body 4 is not limited to this. For example, the second resin molded body 4 may have a shape in which only the coil end portion 121 on the first resin molded body 31 side is fixed in the field coil 12.

Further, as shown in FIG. 4, the second resin molded body 4 is formed in a circular shape in a plan view of the rotor 100, but is not limited thereto. For example, the second resin molded body 4 may have a shape that seals only the other end of the bus bar 33 protruding from the first resin molded body 31. Similarly, the first resin molded body 31 is also formed in a circular shape in a top view of the rotor 100, but is not limited thereto. FIG. 4 is a plan view of the rotor 100 viewed from the positive direction side of the z-axis.

### Method of Manufacturing Rotor

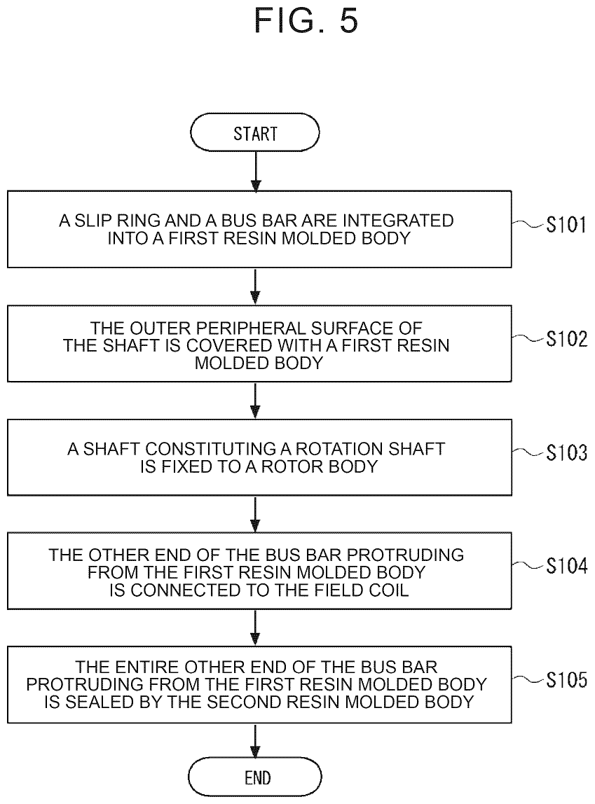

Next, a method of manufacturing the rotor according to the first embodiment will be described. FIG. 5 is a flowchart of a method of manufacturing a rotor according to the present disclosure. Note that the order of the steps is not limited to this, and may be replaced as appropriate.

First, the slip ring 32 and the bus bar 33 are integrated with the first resin molded body 31 (S101). In S101, the slip ring 32 and the bus bar 33 are connected in advance. For example, one end of the bus bar 33 is connected to the inner peripheral surface of the slip ring 32 by welding. Next, the slip ring 32 and the bus bar 33, which are connected to each other, are placed at predetermined positions in a mold (not shown). Then, the first resin molded body 31 is molded by injecting and solidifying the molten resin into the mold, and the slip ring 32 and the bus bar 33 are integrated with the first resin molded body 31. After the slip ring 32 and the bus bar 33 are integrated with the first resin molded body 31, the outer peripheral surface of the slip ring 32 and the other end of the bus bar 33 are exposed from the first resin molded body 31. In S101, the slip ring device 3 is formed by integrating the slip ring 32 and the bus bar 33 into the first resin molded body 31.

Next, the outer peripheral surface of the shaft 2 is covered with the first resin molded body 31 (S102). More specifically, the slip ring device 3 is fixed to the shaft 2 so as to cover the outer peripheral surface of the shaft 2. For example, the slip ring device 3 may be fixed to the shaft 2 by press-fitting the first resin molded body 31 of the slip ring device 3 into the shaft 2, but is not limited thereto.

Next, the shaft 2 constituting the rotating shaft (z-axis) is fixed to the rotor body 1 (S103). In S103, the shaft 2 is fixed to the rotor body 1 so that the slip ring device 3 protrudes from the rotor body 1 in the axial direction of the rotating shaft (z-axis). Here, the order in which the field coils 12 are annularly wound on the outer peripheral surface of the protruding portion 11a of the rotor core 11 may be either before or after the shaft 2 is fixed to the rotor body 1.

Next, the other end of the bus bar 33 protruding from the first resin molded body 31 is connected to the field coil 12 (S104). More specifically, a lead wire (not shown) of the field coil 12 is connected to the other end of the bus bar 33 protruding from the first resin molded body 31.

Next, the entire other end of the bus bar 33 protruding from the first resin molded body 31 is sealed with the second resin molded body 4 (S105). For example, the rotor 100 including the rotor body 1, the shaft 2, and the slip ring device 3 is placed at a predetermined position in a mold (not shown). Then, by injecting and solidifying the second resin molded body 4 melted into the mold, the entire other end of the bus bar 33 protruding from the first resin molded body 31 is sealed by the second resin molded body 4. The shape of the rotor 100 after sealing includes, for example, a shape in which the field coil 12 is sealed to the second resin molded body 4 in the rotor body 1, a shape in which only the coil end portion 121 is fixed to the second resin molded body 4 in the field coil 12, and the like. In addition, only the other end of the bus bar 33 protruding from the first resin molded body 31 may be sealed with the second resin molded body 4.

As described above, according to the rotor and the manufacturing method thereof according to the present disclosure, the bus bar 33 is electrically connected to the slip ring 32 and the field coil 12 in a state of being sealed to the first resin molded body 31 and the second resin molded body 4. According to such a configuration, it is possible to prevent the oil supplied to the rotor body 1 from adhering to the bus bar 33. Therefore, it is possible to prevent the oil from reaching the outer peripheral surface of the slip ring 32.

It should be noted that the present disclosure is not limited to the above embodiments, and can be modified as appropriate without departing from the spirit and scope of the disclosure.

For example, the slip ring 32 and the bus bar 33 are two sets of examples in the first embodiment, but are not limited thereto. For example, if the field coil 12 of the rotor body 1 is three-phase, the slip ring 32 and the bus bar 33 are three sets. In other words, the rotor 100 includes two or more sets of the slip ring 32 and the bus bar 33.

What is claimed is:

1. A rotor comprising:
a rotor body including a field coil;
a shaft fixed to the rotor body and constituting a rotary shaft;
a first resin molded body that covers an outer peripheral surface of the shaft protruding in a direction of the rotary shaft from the rotor body;
a slip ring installed on an outer peripheral surface of the first resin molded body; and
a bus bar, one end of which is electrically connected to the slip ring in the first resin molded body, and the other end of which protrudes from the first resin molded body to be electrically connected to the field coil, wherein
the entire other end of the bus bar protruding from the first resin molded body is sealed by a second resin molded body that is separate from the first resin molded body.

2. The rotor according to claim 1, wherein:
the field coil includes a coil end portion at both end portions in the direction of the rotary shaft of the rotor body; and
the coil end portion on the first resin molded body side is fixed by the second resin molded body.

3. The rotor according to claim 2, wherein the field coil is sealed by the second resin molded body in the rotor body.

4. A method of manufacturing a rotor, comprising:
integrating a slip ring and a bus bar with a first resin molded body;
covering an outer peripheral surface of a shaft with the first resin molded body; and
fixing the shaft constituting a rotary shaft to a rotor body, and causing the first resin molded body to protrude in a direction of the rotary shaft from the rotor body, wherein:
one end of the bus bar sealed in the first resin molded body is electrically connected to the slip ring installed on an outer peripheral surface of the first resin molded body, and the other end of the bus bar protruding from the first resin molded body is electrically connected to a field coil provided in the rotor body; and
the entire other end of the bus bar protruding from the first resin molded body is scaled by a second resin molded body that is separate from the first resin molded body.
